(19) United States
(12) Patent Application Publication
(10) Pub. No.: US 2012/0079262 A1
(43) Pub. Date: Mar. 29, 2012

(54) START-UP CONTROL APPARATUS AND METHOD

(75) Inventor: LI-WEN GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen (CN)

(21) Appl. No.: 13/170,357

(22) Filed: Jun. 28, 2011

(30) Foreign Application Priority Data
Sep. 29, 2010 (CN) 201010296625.9

(51) Int. Cl. G06F 9/00

(52) U.S. Cl. 713/2

(57) ABSTRACT

A start-up control apparatus includes a control chip, an advanced configuration and power management interface (ACPI) controller, and a firmware. The control chip includes an analysis module and a control module. The ACPI controller is used for receiving a trigger signal and sending a start-up signal corresponding to the trigger signal to the control module if a computer system is powered off. The firmware is used for sending a status signal to the analysis module after the firmware finishes initialization. The analysis module is further adapted to send the trigger signal to the ACPI controller after receiving the status signal, and the control module is adapted to send the start-up signal to a power supply to provide power for powering on the computer system.

### CROSS-REFERENCE TO RELATED APPLICATIONS

Relevant subject matter is disclosed in co-pending U.S. patent application Ser. No. entitled “START-UP CONTROL APPARATUS AND METHOD,” Attorney Docket Number US35323, U.S. patent application Ser. No. ______, Filed on ______.

### BACKGROUND

1. Technical Field

The present disclosure relates to start-up control apparatuses and methods.

2. Description of Related Art

A server generally includes a variety of firmwares, for example, a baseboard management controller (BMC). A firmware can be initialized when the server is started up. However, initialization may take a long period of time. Different firmwares may have different initialization times. On start-up, the power supply provides power for powering on the server after a reference time defined by the server. If the reference time exceeds the initialization time of some firmwares, the server may have problems because the firmwares have not finished initialization.

### BRIEF DESCRIPTION OF THE DRAWINGS

FIG. 1 is a schematic view of a start-up control apparatus in accordance with an embodiment.

FIG. 2 is a flow chart of a start-up control method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

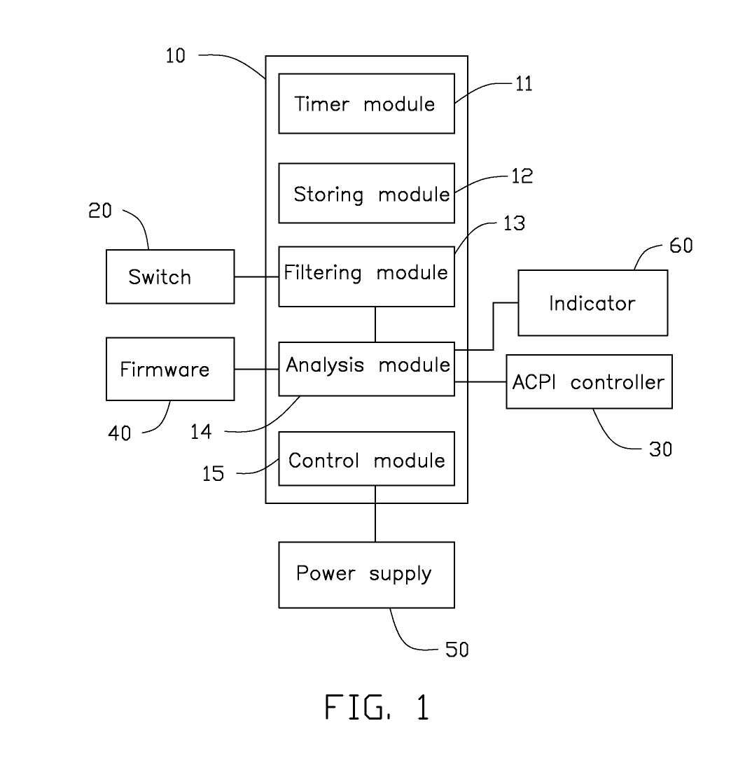

Referring to FIG. 1, a start-up control apparatus applied in a computer system includes a control chip 10, a switch 20, an advanced configuration and power management interface (ACPI) controller 30, a firmware 40, a power supply 50, and an indicator 60. In one embodiment, the computer system is a server.

The control chip 10 includes a timer module 11, a storing module 12, a filtering module 13, an analysis module 14, and a control module 15.

The switch 20 is connected to the filtering module 13. The filtering module 13 is connected to the analysis module 14. The firmware 40 is connected to the analysis module 14. The analysis module 14 is connected to the ACPI controller 30 and the indicator 60. The power supply 50 is connected to the control module 15. In one embodiment, the firmware 40 is a BMC, and the ACPI controller 30 is disposed in a south bridge chip.

A power source of the server, for example, a battery, provides power for the control chip 10, the ACPI controller 30, and the firmware 40 when the server is connected to an external power source. At this time, the timer module 11 begins to record time. The storing module 12 stores a reference time. The switch 20 creates a trigger signal. The filtering module 13 filters the trigger signal. In one embodiment, the filtering module 13 uses glitch filtering.

The analysis module 14 determines if the analysis module 14 received a status signal from the firmware 40. If so, the analysis module sends the filtered trigger signal to the ACPI controller 30. If not, the analysis module 14 further determines if time kept by the timer module 11 exceeds the reference time when the control module 14 does not receive the status signal. If the time exceeds the reference time, the analysis module 14 sends the filtered trigger signal to the ACPI controller 30 and sends an indicating signal indicating initialization of the firmware 40 was not achieved to the indicator 60. In one embodiment, the indicator 60 is a light-emitting diode (LED).

The ACPI controller 30 receives the filtered trigger signal and sends a start-up signal corresponding to the filtered trigger signal to the control module 15 after determining the server is powered off. The firmware 40 sends the status signal to the control module 14 after the firmware 40 has been initialized.

The control module 15 sends the start-up signal to the power supply 50 to provide power for powering on the server after determining other components are initialized.

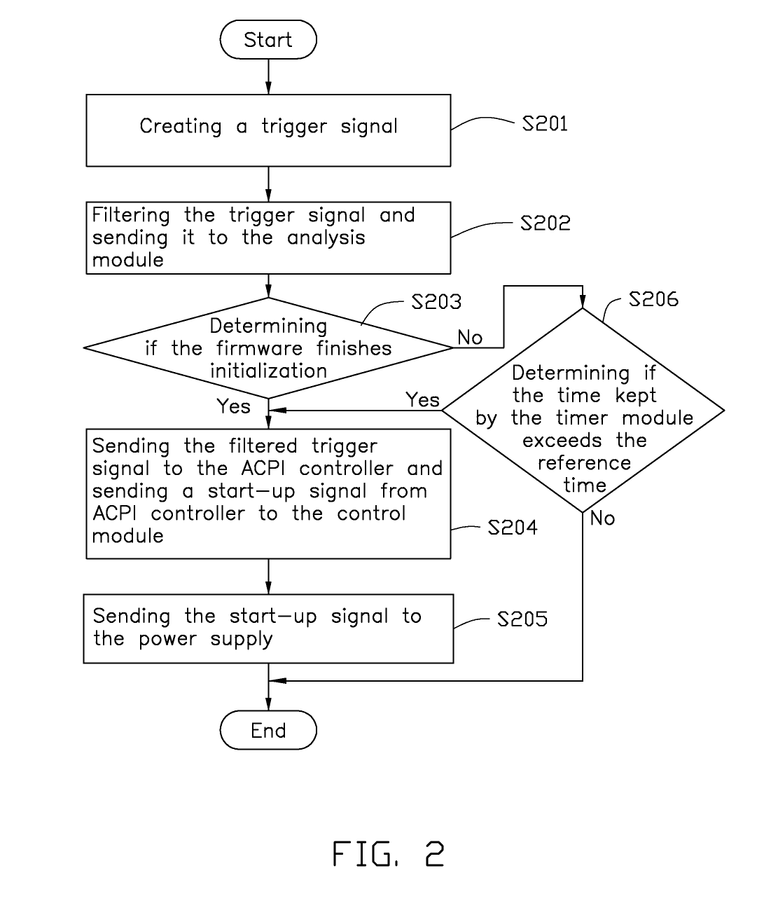

Referring to FIGS. 1 and 2, a start-up method is shown. An embodiment of the method is as follows.

In step S201, the switch 20 is pressed to create a trigger signal.

In step S202, the filtering module 13 filters the trigger signal and sends the filtered trigger signal to the analysis module 14.

In step S203, the analysis 14 determines if the analysis module 14 receives the status signal from the firmware 40. If so, the process continues to step S204. If not, the process continues to step S206.

In step S204, the analysis module 14 sends the filtered trigger signal to the ACPI controller 30, and the ACPI controller 30 sends a start-up signal corresponding to the filtered trigger signal to the control module 15 after determining the server is powered off.

In step S205, the control module 15 sends the start-up signal to the power supply 50 to provide power for powering on the server.

In step S206, the analysis module 14 determines if time kept by the timer module 11 exceeds the reference time. If so, the analysis module 14 sends an indicating signal for indicating initialization of the firmware 40 was not achieved to the indicator 60, and the process returns to step S204. If not, the process is over.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed. Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A start-up control apparatus for a computer system, comprising:
a control chip comprising an analysis module and a control module;
an advanced configuration and power management interface (ACPI) controller, the ACPI controller being adapted to send a start-up signal to the control module if a power of the computer system is off; and
a firmware adapted to send a status signal to the analysis module after the firmware finishes initialization;
wherein the analysis module is further adapted to send a trigger signal to the ACPI controller after receiving the status signal, and the control module is adapted to provide power for powering on the computer system.

2. The start-up control apparatus of claim 1, wherein the control chip further comprises a storing module storing a reference time and a timer module recording time after the firmware is powered on; the analysis module is further adapted to determine if time kept by the timer module exceeds the reference time after the analysis module does not receive the status signal; the control module is further adapted to send the start-up signal to the power supply to provide power for powering on the computer system if the time kept by the timer module exceeds the reference time.

3. The start-up control apparatus of claim 2, further comprising an indicator, wherein the analysis module is further adapted to send a signal indicating initialization of the firmware was not achieved to the indicator when the time kept by the timer module exceeds the reference time.

4. The start-up control apparatus of claim 1, further comprising a filtering module adapted to filter the trigger signal before the trigger signal is sent to the ACPI controller.

5. The start-up control apparatus of claim 1, wherein the firmware is a baseboard management controller.

6. A start-up control method, the method comprising:
providing a switch creating a trigger signal and a control chip;
sending the trigger signal to an advanced configuration and power management interface (ACPI) controller by the control chip;
sending a start-up signal corresponding to the trigger signal by the ACPI controller to the control chip after determining a power of a computer system is off; and
sending the start-up signal by the control chip to the power supply to provide power for powering on the computer system.

7. The start-up control method of claim 6, wherein the control chip records time when the firmware is power on; the control chip judges if time kept by the control chip exceeds a reference time after not receiving the status signal, and if so, the control chip sends the trigger signal to the ACPI controller.

8. The start-up control method of claim 7, wherein the control chip sends an indicating signal for indicating initialization of the firmware was not achieved to the indicator when the time exceeds the reference time.

9. The start-up control method of claim 6, wherein the control chip filters the trigger signal before sending the trigger signal to the ACPI controller.

10. The start-up control method of claim 6, wherein the firmware is a baseboard management controller.
